(19) United States
(12) Patent Application Publication
(10) Pub. No.: US 2009/0058615 A1
(43) Pub. Date: Mar. 5, 2009

(54) CLOTHING HISTORY APPLICATION AND METHOD FOR MOBILE STATION HAVING AN INTEGRATED TRANSPONDER READER

(75) Inventor: CHARLES SCHULTZ, NORTH MIAMI BEACH, FL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/848,198

(22) Filed: Aug. 30, 2007

(51) Int. Cl. H04B 7/00

(52) U.S. Cl. 340/10.4

(57) ABSTRACT

The various embodiments provide an application with which a mobile station having a transponder reader may record a clothing item's date of wear, a list of other items it was worn with, etc., and a plurality of Global Positioning System (GPS) locations where the clothing item was worn at particular times. The data may be recorded by explicit action of the wearer, and may further include recording who the wearer communicated with, and identify nearby devices belonging to members of the wearer's social network. The information recorded may be provided to a server to create a clothing history record transferable with an article of clothing.

### FIELD OF THE DISCLOSURE

The present disclosure is related to articles of clothing having embedded transponder tags, transponder tag readers, particularly mobile stations having transponder tag readers, and methods of data collection using said transponder tags and methods of storing and presenting data using markup languages.

### BACKGROUND

Fashion conscious consumers like to wear a variety of clothes and not repeat their wardrobes under similar situations such as with the same people at the same places. Clothing is now available with transponder tags such as RFID™ tags which may provide convenience to shoppers in a store by enabling quick identification of items.

However, such tags of usually unused after purchase of the items and thus do not provide subsequent information to the wearer.

Thus what is needed is an apparatus and method for making use of clothing transponder tags by wearers of the clothing items regarding when the item was worn, where and with whom.

### BRIEF DESCRIPTION OF THE DRAWINGS

FIG. 1 is a block diagram illustrating a network infrastructure in which a mobile station may operate in accordance with the embodiments.

FIG. 2 is a diagram of clothing set tag definitions for storing clothing information in accordance with the embodiments.

FIG. 3 is a block diagram illustrating the primary components of a mobile station in accordance with some embodiments.

FIG. 4 is a block diagram illustrating a mobile station application in accordance with an embodiment.

FIG. 5 is a block diagram illustrating an exemplary menu format of some embodiments.

FIG. 6 is a flow diagram illustrating an initial configuration operation of embodiments.

FIG. 7 is a flow diagram illustrating the basic operation of embodiments.

FIG. 8 is a block diagram of transponder tag information bit fields in accordance with some embodiments.

FIG. 9 is a block diagram illustrating an exemplary menu for sharing clothing and wardrobe information in accordance with an embodiment.

### DETAILED DESCRIPTION

In accordance with the embodiments a wearer may use a mobile station having a transponder reader, such as an RFID™ reader, to record a clothing item's date of wear, a list of other items it was worn with, etc., and a plurality of Global Positioning System (GPS) locations where the clothing item was worn at particular times. The data may be recorded by explicit action of the wearer, and may further include recording who the wearer communicated with, and identify nearby devices belonging to members of the wearer's social network.

The information collected may be stored locally on the mobile station's memory, on a removable memory card or on a remote storage device connectable to the mobile station via a network. The stored information may be formatted for publication on the wearer's blog site as “clothescasting” information. Further, images of the clothing item may be retrieved from a manufacturer or third party database and added to the blog information along with “Where I went” and “Who I was with” information. Such images and information may be used to present and promote the clothing of various labels.

The wearer's mobile station may subsequently retrieve the stored information to assist the user in future clothing decisions by responding to voice or menu based queries such as “What did I wear the last time I was with Dave?” or “What did I wear to school last Tuesday?” or “When was the last time I wore these jeans?”

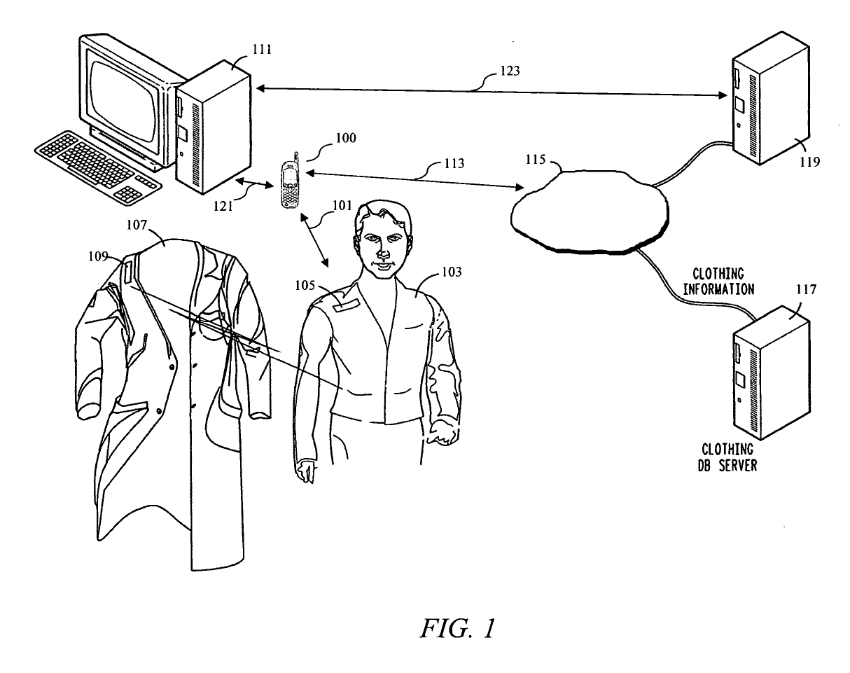

FIG. 1 illustrates operation of a mobile station 100 in accordance with various embodiments. The wearer and mobile station 100 user wears an article of clothing 103 having an embedded transponder tag 105. The mobile station 100 having a built-in transponder reader may perform a query and response operation 101 to obtain the clothing information contained by the transponder tag 105. Other articles of clothing, such as coat 107 having transponder tag 109, may by queried within approximately the same time, for example, by sequentially performing the query and response operation for all articles of clothing the wearer is wearing, or by performing a global scan and response depending on the implementation of the mobile station 100 transponder reader. It is expected that, transponder readers being understood by one of ordinary skill, may be easily implemented by one of ordinary skill for the various embodiments described herein and thus further details with respect to the mobile station 100 transponder reader are not necessary for describing to one of ordinary skill how to make and use the various embodiments.

The mobile station 100 may, further in some embodiments, query a clothing database server 117 via database query/response 113 using a suitable network 115. The suitable network 115 as described herein includes any combination of suitable networks such as the mobile station 100 carrier wireless network, the Internet, Wireless Local Area Networks (WLAN) etc., such that, the mobile station 100 may the query/response 113 with the clothing database server 117.

The query/response 113 provides the clothing database server 117 with clothing reference information collected by the mobile station 100 transponder reader from transponder tag 105. The clothing database server 117 may in response provide further detailed information regarding the clothing item 103 such as, but not limited to, an image file for clothing item 103.

In some embodiments the wearer may use the mobile station 100 to transmit clothing information to a blog server 119. Alternatively, the mobile station 100 may provide the clothing information to a personal computer 111 via a suitable link 121 such as Bluetooth™, or any other suitable connection such as a wired serial connection. The mobile station 100 may also share clothing information with other mobile devices by using either the blog server 119 or an application that provides various user options for sharing clothing information. The wearer may then format the information as desired and transmit it via a network connection, such as Internet connection 123 to the blog server 119 or to another mobile station or group of mobile stations.

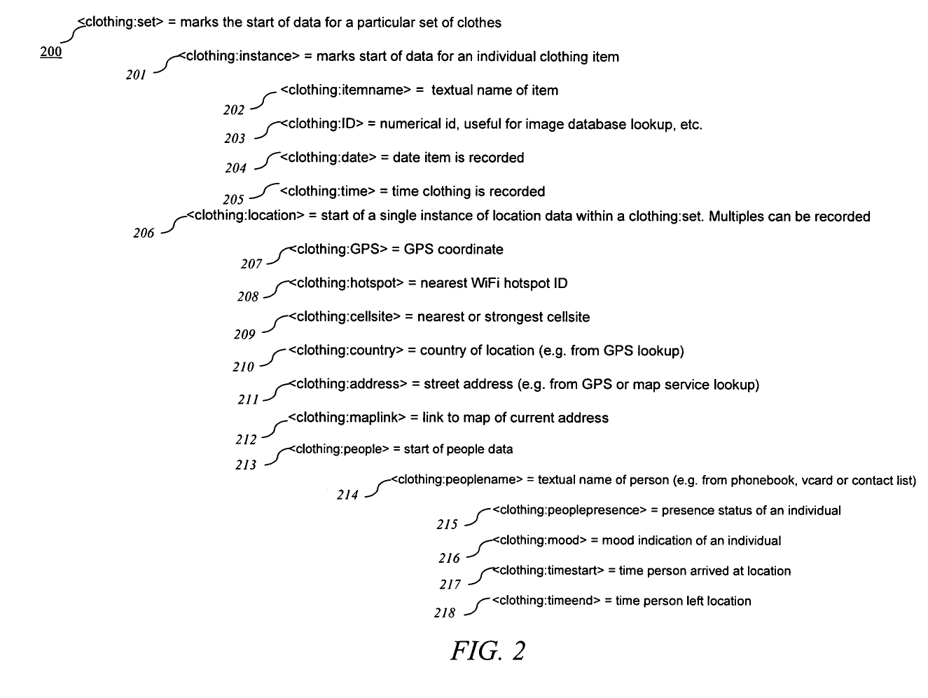

FIG. 2 illustrates clothing information and how it is stored in a “<clothing:set>” tag 200 in accordance with the embodiments. The <clothing:set> tag 200 marks the start of data for a particular set of clothes. The clothing set further contains a “<clothing:instance>” tag 201, which marks the start of data for an individual clothing item. Each clothing item will include a <clothing:itemname> tag 202, which stores a textual name of the item; a <clothing:ID> tag 203 which is a numerical ID, useful for image database lookup; a <clothing:date> tag 204 which provides the date an item is recorded; and a <clothing:time> tag 205 which provides the time a clothing item is recorded.

Locations of interest where clothes items worn are worn are also recorded within the <clothing:set> tag 200 information. Any or all of the following information may be recorded for a given instance and therefore a <clothing:location> tag 206 indicates the start of a single instance of location data within a <clothing:set>. Multiple <clothing:location> tags 206 may exist and may include the following information tags: a <clothing:GPS> tag 207 for storing a GPS coordinate; a <clothing:hotspot> tag 208, for indicating the nearest WiFi hotspot ID; a <clothing:cellsite> tag 209 for indicating the nearest or strongest cell site; a <clothing:country> tag 210 for country of location (e.g. from GPS lookup); a <clothing:address> tag 211 for providing a street address (e.g. from GPS or map service lookup); and a <clothing:maplink> tag 212 for storing a link to map of current address, such as a map obtained via the Internet.

The <clothing GPS> tag may be populated by the mobile station, via a GPS receiver included in the mobile station, or may be obtained by accessing a location server where the location server provides the GPS coordinates. Various ways of obtaining location information are known to one skilled in the art and therefore the <clothing GPS> tag 207 may be populated by any of the various ways such as, by a mobile station having a GPS, by a locations server, or by some combination as understood by one of ordinary skill.

Once the <clothing GPS> tag 207 is populated, other tags such as the <clothing:country> tag 210, <clothing:address> tag 211, <clothing:maplink> tag 212 may be obtained by the mobile station by performing a GPS or map service lookup.

The embodiments may also provide tags for recording people around the wearer while particular clothing sets are worn. Therefore, within the hierarchy of the <clothing:location> tag 206, is a <clothing:people> tag 213 which indicates the start of “people data.” The <clothing:people> tag 213 people data comprises a <clothing:peoplename> tag 214 per person for providing a textual name of a person (e.g. from phonebook, vcard or contact list); a <clothing:peoplepresence> tag 215 to indicate the presence status of an individual; a <clothing:mood> tag 216 for providing a mood indication of an individual; a <clothing:timestart> tag 217 for indicating a time a person arrived at location; and a <clothing:timeend> tag 218 providing a time that a person left the location.

Thus the tags as described with respect to FIG. 2 may be defined as “clothescasting” information and may be used as a format for posting a blog by the wearer, such as by blog server 119. The clothing tags may be Hypertext Markup Language (HTML) tags, Extensible Markup Language (XML) tags, or any other suitable markup language tags for defining information, storing information and defining how such information is displayed on a display such as, but not limited to, a mobile station display, computer display or a World Wide Web (WWW) page on any device or mobile station WAP page, etc. The clothing tags may be reformatted for various display types as appropriate by WYSIWYG applications etc., for creating Web pages and the clothing tags may be automatically populated by mobile station applications which may include or may interface with various Web applications for formatting the clothing tags or including the clothing tags along with other tags, such as but not limited to HTML tags XML tags, WAP-ML tags, etc. for display by various mobile stations and/or other devices.

The information may be sent and received in a variety of ways such as, but not limited to, Push-to-X, Really Simple Syndication (RSS) feeds, etc. Further, in some embodiments, the information posted by the wearer may be collected by the manufacturer and stored in a server such as the clothing database server 117, and may be used for providing clothing marketing information, or other marketing information to the wearer. This information collection may be offered to the wearer as a voluntary program and provide various incentives to the user such as discounts, occasional free items, etc., for the wearers participation in the information gathering by the manufacturer, and also for the use of the manufactures items at various social occasions.

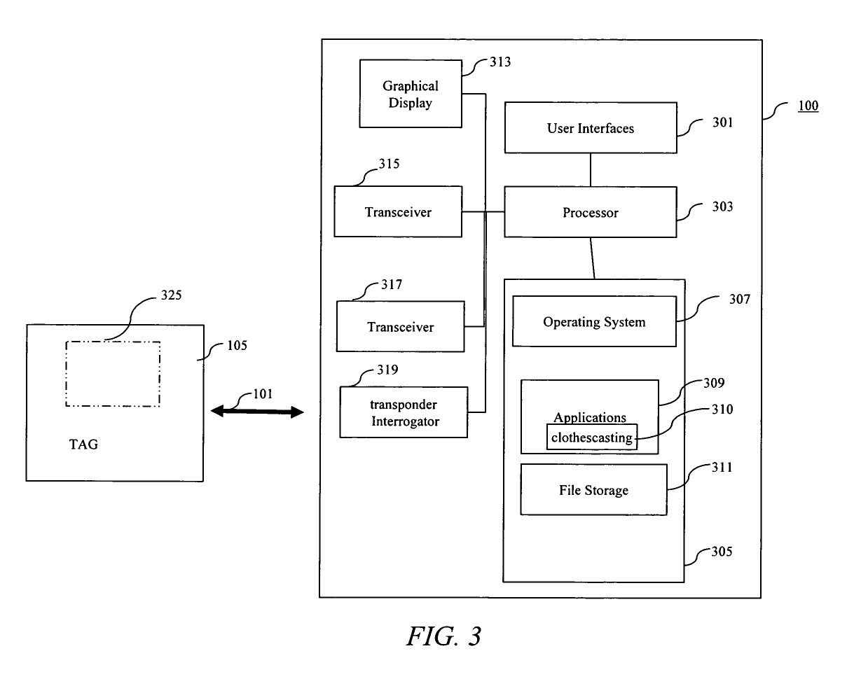

The clothescasting information is in most embodiments, used by an application residing on the mobile station 100 to provide the wearer with information used to select wardrobes for various occasions. The clothescasting information may also be shared with other mobile stations for the purpose of matching, or not matching, wardrobes for certain times, events, etc., and may also be recorded as a clothing history which may be accessed later when an article of clothing is transferred. For example, the mobile station may use a contact list or address book list, which may be associated with, and/or used by, other applications such as email, Instant Messaging, Push-to-Talk/Push-to-X, etc., as a source for selecting other users to send and receive clothescating information to and from, respectively. Turning to FIG. 3, the mobile station 100 comprises an transponder interrogator component 319 which can transmit and receive signals over the air interface 101, to read data from the transponder tag 105. After reading the information provided by tag 105, the mobile station 100 may transmit the information to the blog server 119 via any suitable network connection and any suitable air interface. As will be described in further detail below, the mobile station 100 may also provide the information to other mobile stations via various techniques.

Mobile station 100 comprises user interfaces 301, at least one processor 303, and a memory 305. Memory 305 has storage sufficient for the mobile station operating system 307, applications 309 and general file storage 311. Mobile station 100 user interfaces 301, may be a combination of user interfaces including but not limited to a keypad, touch screen, voice activated command input, and gyroscopic cursor controls.

Mobile station 100 has a graphical display 313, which may also have a dedicated processor and/or memory, drivers etc. which are not shown in FIG. 3. It is to be understood that FIG. 3 is for illustrative purposes only and is for illustrating the main components of a mobile station in accordance with the present invention, and is not intended to be a complete schematic diagram of the various components required for a mobile station. Therefore, a mobile station may comprise various other components not shown in FIG. 3 and still be within the scope of the present embodiments.

Returning to FIG. 3, the mobile station 100 also comprises a number of transceivers such as transceivers 315 and 317. Transceivers 315 and 317 may be for communicating with various wireless networks such as, but not limited to, 802.11, GSM, CDMA, UMTS, etc. In addition to the transceivers 315 and 317, mobile station 100 comprises an additional wireless capability, specifically transponder interrogator 319, for communicating with transponder tags such as transponder tag 105 using air interface 101. The transponder tag 105, is exemplary and comprises and internal antenna 325, and the transponder interrogator 319 likewise has an internal antenna although this antenna is not explicitly illustrated in FIG. 3. A user/wearer may activate the mobile station 100 transponder interrogator 319 by activating, for example, a button which is part of the user interfaces 301. Any suitable user activation of transponder interrogator 319 may be used and would still remain within the scope of the present embodiments. The data collected by the transponder interrogator will henceforth be referred to as “clothescasting information” although the clothescasting information as described herein will comprise information additional to the information collected by the transponder interrogator 319. Therefore, the information collected by the transponder interrogator 319 is a subset of the clothescasting information as defined herein. Any clothescasting information is utilized and accessed by a clothescasting application 310 which resides along with the various applications 309 of the mobile station 100.

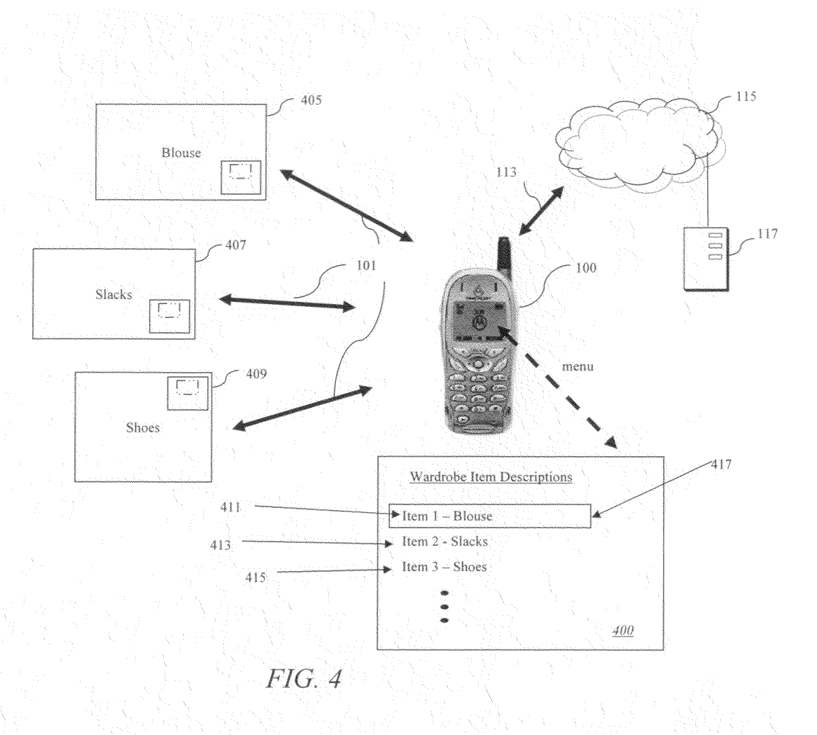

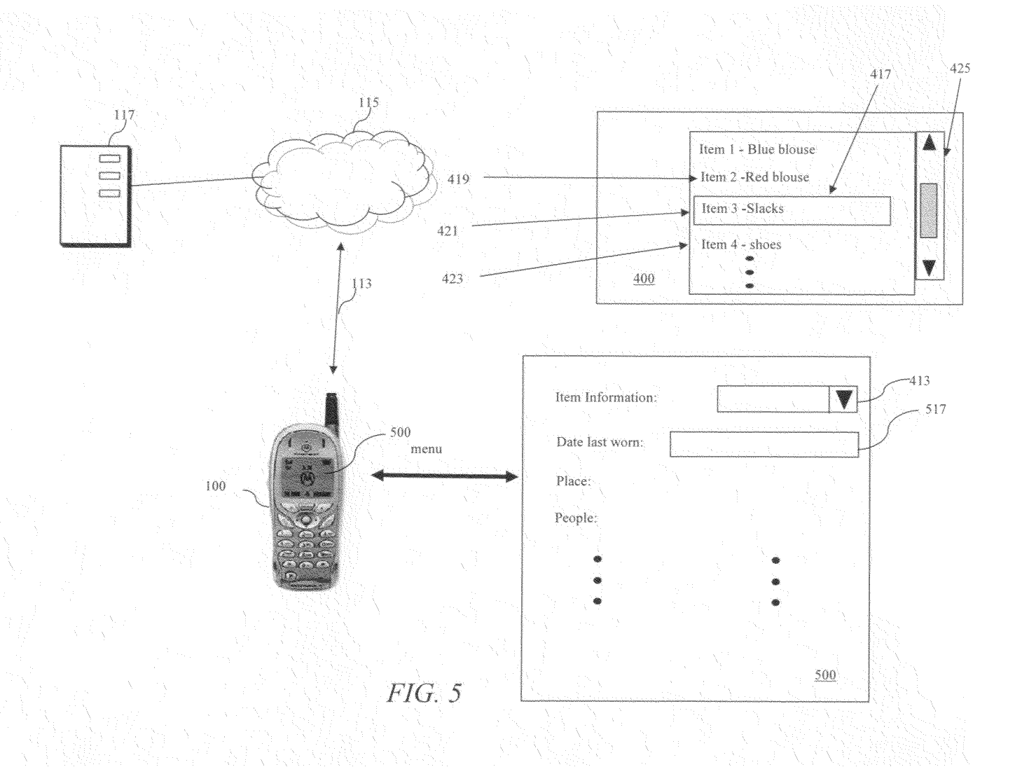

FIG. 4 and FIG. 5 provide further details of the mobile station 100 clothescasting application 310 in accordance with an embodiment. In FIG. 3, mobile station 100 may interrogate a set of transponder tags using air interface 101. In FIG. 3, a set of clothing items and/or accessories may have transponder tags, for example; a blouse 405, slacks 407, shoes 409, or other items such as a purse or handbag. The mobile station 100 may in some embodiments have a priori knowledge of the transponder information contained by a set of tags, for example, the items may have been previously scanned.

In that case, mobile station 100 may have the known transponder tag information stored in a file storage 311 the mobile station 100 memory 305. The clothescasting application 310 of the mobile station 100 may have a timing setting, which in some embodiments may be a user settable preference, such that the mobile station 100 will perform an transponder interrogation automatically at set time intervals using transponder interrogator 319. The mobile station transponder interrogator 319 may use a singulation protocol so as to check each of the tagged items without encountering problems with conflicting tag responses.

Alternatively, the mobile station 100 may attempt to generally interrogate the tags and use a tree walking protocol to determine either the number of tags present or to determine the information from each item for comparison to the previously stored information.

The clothescasting information will be displayed on a display of mobile station 100, for example by menu 400, and will show an entry for each item scanned for example, “item 1—blouse” 411, “item 2—slacks” 413 and “item 3—shoes,” etc. where the item number and textual descriptions correspond to the populated <clothing:set> tag 200 which includes a <clothing:itemname> tag 202 for each item as was discussed above with respect to FIG. 2. The items will then be selectable, for example, by using cursor 417.

FIG. 5 illustrates an exemplary menu format of some embodiments, in which the clothescasting information may include downloaded information, based on the scanned information as was discussed previously. For example, in FIG. 5 mobile station 100 may access the clothing database information server 117 using wireless network 115 and wireless interface 113 and use the scanned clothing information to obtain additional information to use for populating the clothing set tags as described with respect to FIG. 2. In some embodiments, the mobile station 100 may also share currently obtained, and/or previously stored, clothescasting information to update a “clothing history” database stored for example, by clothing database information server 117.

The mobile station 100 may display the menu 400, which may be a user interface applet provided by clothing information database server 117 over network connections 113 through wireless network 115. The menu 400 as discussed will provide wardrobe entries for scanned information in which the entries are selectable using a cursor 417. A selected entry may call a different menu, the item information menu 500.

The menu 500 may provide a display of the scanned clothing information and may also display information downloaded from the clothing database server 117. The cursor 517 may also be used to select specific information segments and allow entry of additional information by the user, or editing of existing entrires. For example the menu 500 may provide a “date last worn,” “place” and “people” information field in which the fields correspond to populated clothing information tags as described and shown in FIG. 2. The view of menu 500 may be changed to a different clothing item via a pull down selectable menu such as pulldown menu 413.

It is to be understood that the menus illustrated by FIG. 4 and FIG. 5, and any other figures used herein for describing the various embodiments, are for exemplary purposes only and that many possible menu configurations are conceivable, and that any such conceivable menu configurations would remain within the scope of the various embodiments.

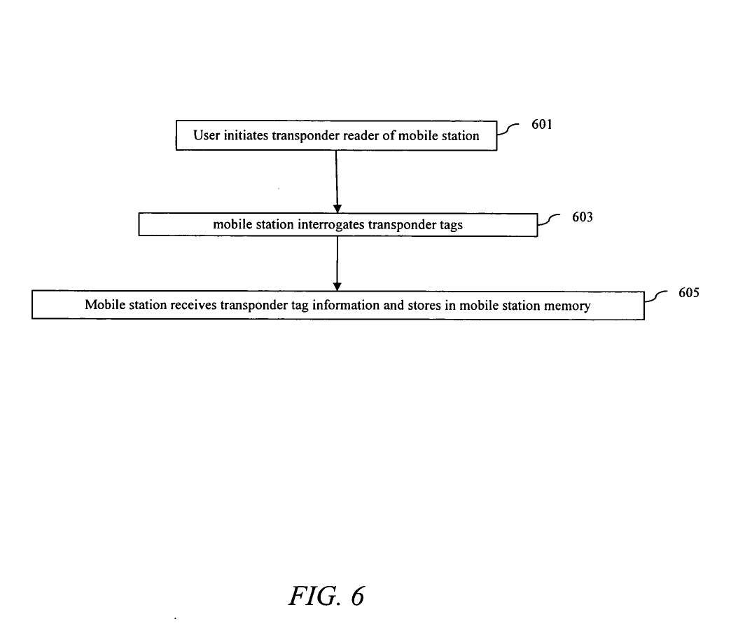

FIG. 6 is a flow diagram illustrating an initial configuration operation of embodiments wherein a wearer may pre-scan in items from the wearer's wardrobe. In block 601, the mobile station user may initiate interrogation of one or more transponder tags, such as the transponder tags associated with various clothing items or accessories. The mobile station interrogates the tag in block 603, and stores the tag information in memory in block 605. The mobile station 100 user may add additional descriptive information using menus such as the menus described in FIG. 4 and FIG. 5.

The tag information may be specific to the items, or it may be generic information that is associated with the items by the user, by entering the appropriate association information into memory using clothescasting application menus 400 and 500. It is to be understood that each individual tag information should in some way be unique, such that each tag can uniquely identify the item to which it is associated.

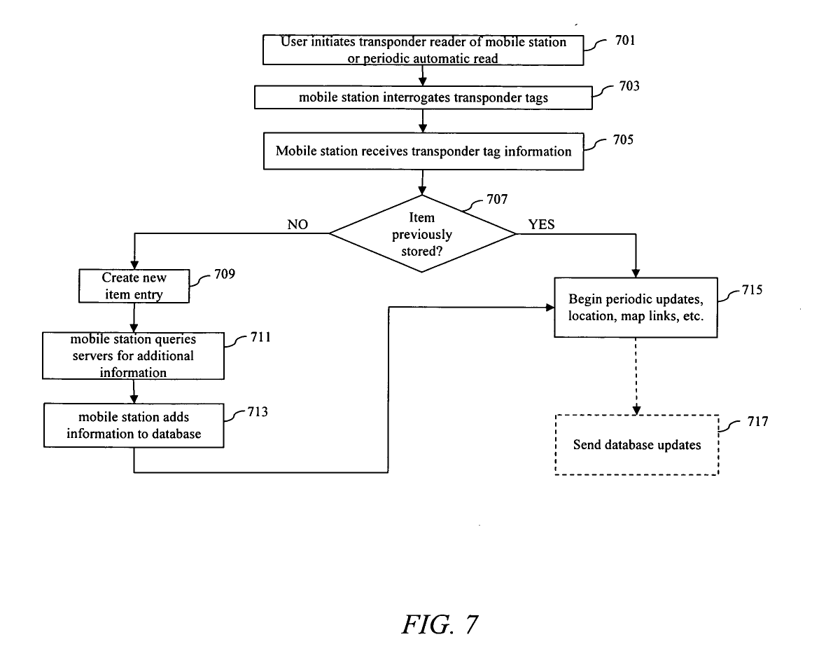

FIG. 7 is a flow diagram illustrating the basic operation of embodiments. In block 701, the user may initiate a clothescasting application which performs a periodic automatic reading of transponder tags. Some embodiments may further incorporate a timer which may have an interval configurable by a user, or a default setting optimized for minimal power consumption by the mobile station battery. Upon timeout, the mobile station may interrogate the transponder tags. The interrogation may use a singulation protocol based upon the previously entered tag information per the procedure illustrated in FIG. 6. In other embodiments, a tree walking protocol may be employed.

In block 703, the mobile station interrogates the transponder tags and receives the tag information and in block 705. The mobile station may compares the information with previously stored information in 707. If all items scanned are previously listed in memory, a timer may be set for periodic updates as in 715.

If one or more of the items is not detected, the mobile station will create a new item entry 709 and may interrogate various servers such as a clothing information database server 117, or location servers for additional information in 711 and add the information to the clothescasting database in 713. The mobile station may then continue with periodic updates for the new items as in 715. The user may add or edit information as was previously discussed. Also, as previously discussed the mobile station may provide periodic updates to the clothing information database server 117 either by an explicit user action or by an optional application setting such that updates are automatically provided to the server 117 as shown in 717. The database updates are clothing history record updates related to individual articles of clothing.

Returning to FIG. 5, the wearer may later access the scanned and updated information when selecting wardrobe items for a particular occasion by checking the menu 500 and viewing information such as, but not limited to, the “date last worn,” “place,” and “people” indicating where and at what time the wearer wore a specific item and who saw the wearer at that specific time.

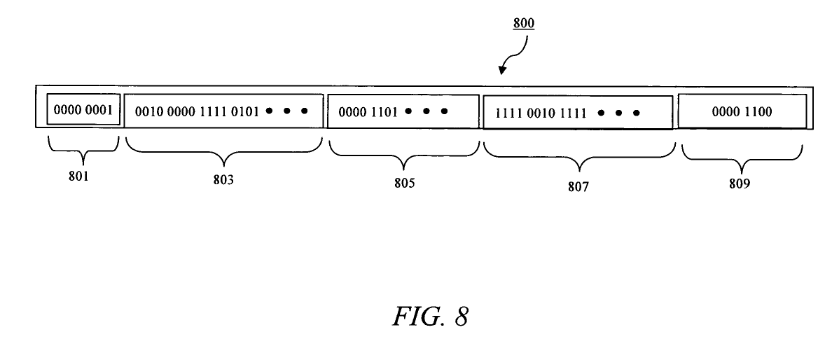

FIG. 8 illustrates further details of transponder tag information in accordance with some embodiments. In FIG. 8, the transponder tag information 800 is represented as a series of bit fields. The bit fields in some embodiments may conform to standards applicable to an Electronic Product Code (EPC). For example, a first bit field 801 may be a header or flag and contain 8 bits. The second bit field 803 may conform to the EPC manager field and contain 28 bits. The third bit field 805 may be designated as an object class field and contain 24 bits. The fourth bit field 807 may be a serial number field and contain 36 bits. Additionally, an optional bit field 809 may provide a check digit, which may be 8 bits in length, for the purpose of verification of the transponder tag information transfer. For example, the bit fields 801, 803, 805, and 807 may when input into a checking algorithm produce the check digit provided by bit field 809. The checking algorithm may be executed by mobile station processor 303 as a mobile station application 309 stored in mobile station memory.

It is to be understood that the bit fields illustrated by FIG. 8 are exemplary only and that any segregation of bit fields is possible and that any such bit segregations would remain in accordance with the embodiments. Further, the embodiments may use various overall bit lengths such as, but not limited to 96 bits, 256 bits, 512 bits or greater and that the segregation of bit fields may be made in any manner appropriate for a particular application and would remain in accordance with the embodiments. Further, although certain transponder tag bit length storage may be standardized by the transponder tag industry, bit lengths of less than 96 bits, in which a 96 bit length is generally made use of by Electronic Product Codes (EPCs) for example, may be used and remain in accordance with the embodiments. Further, in some embodiments, various bit fields of transponder tag information 800 may be used in various ways.

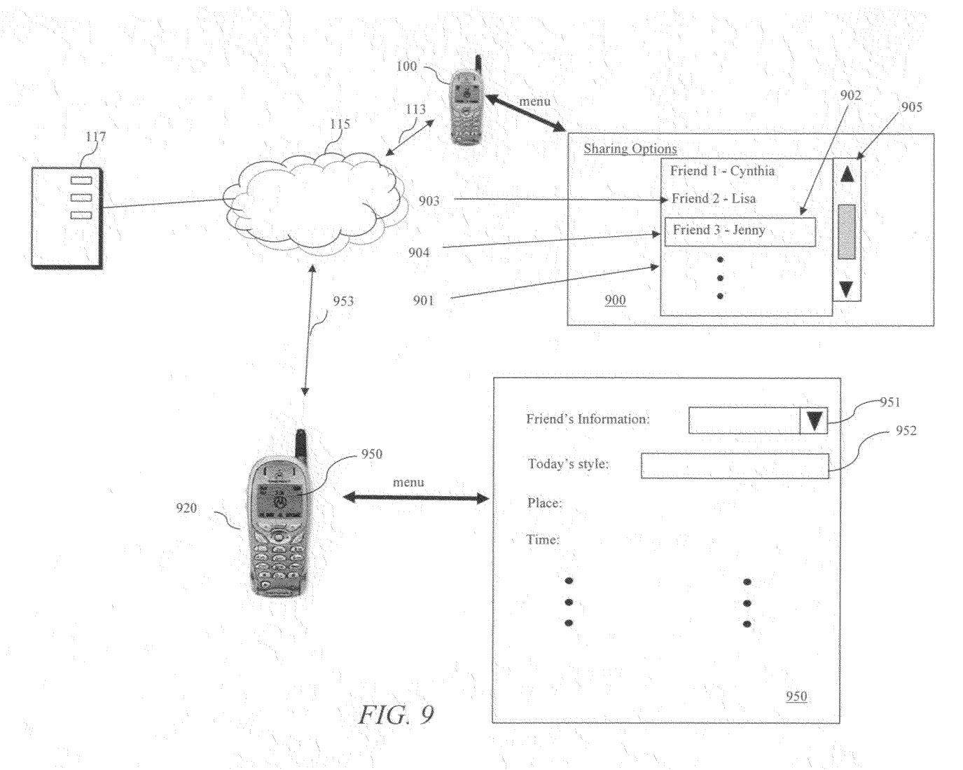

FIG. 9 illustrates clothescasting information sharing by mobile stations in accordance with an embodiment. The mobile station 100 clothescasting application 310 may provide a “Sharing Options” menu 900 which provides a selectable list of friends 901. The friends list 901 may be scrollable using a scroll bar 905 and selectable via a cursor 902, such that various friends 903, 904, etc., may be selected. In the example illustrated in FIG. 9, “Jenny” 904 may be selected using the cursor 902. As previously discussed, all figures used for describing the various embodiments herein, and thus including FIG. 9, are for exemplary purposes only and therefore many possible menu configurations are conceivable, and any such conceivable menu configurations remain within the scope of the various embodiments.

Returning to FIG. 9, the mobile station 100 user may select any friends from the friends list 901 or create groups of friends that may be selected such that all members of a selected group would receive the clothescasting information. The mobile station 100 may use the network 115 an wireless interface 113 to send the information to the clothing information database server 117 and/or to another mobile station such as mobile station 920.

Mobile station 920, also having the clothescasting application 310, may display a menu 950 which allows selecting friends from a friends list 951, which may be a pull down menu as shown in FIG. 9. The menu may then display various clothing information such as “today's style” 952, a “place,” “time” etc. and may have information for each article of clothing worn by any selected friend.

Further, the mobile station 920 clothescasting application 310 may make a comparison of the mobile station 920 user's clothing, via the scanned clothing information, with any selected friend clothing information, and display the comparison results to the mobile station 920 user. The mobile station 920 user may then determine if they will match, or not match, the mobile station 100 user's clothing for a specific event, time, place, etc. The clothescasting information to and from friends mobile stations may be sent and requested using Push-to-x capabilities of the mobiles phones. For example, the mobile station 100 may select a friend or group of friends from a contact list and use a Push-to-X button to select the friend or group of friends for sending the clothescasting information. Push-to-X may also be used to obtain the clothescasting information of one or more friends in a similar manner. For example, the mobile station 100 user may select a friend or group of friends and use a Push-to-X button to request clothescasting information. Alternatively or additionally, the information may be sent and received using Really Simple Syndication (RSS) feeds.

In an additional embodiment, the mobile station 100 may update the clothing information database server 117, or a blog server such as blog server 119 in FIG. 1, and provide a notification to mobile station 920 that an update has been made. The notification may also provide link and/or an authorization to access the updated clothing information. The mobile station 920 may then use an appropriate wireless interface 953 to access the clothing information database server 117 or blog server 119.

The clothescasting application 310 may act in conjunction with Instant Messaging applications and/or Push-to-X applications, where the clothescasting application 310 provides presence information and updates clothescasting information based on friends being “present” during specific times. The updates may in some embodiments be provided by using a Push-to-X capability in which the mobile station user may “Push-to-Update” the clothescasting information to a friend or group of friends as discussed above.

The clothing information database server 117 as described with respect to the various embodiments may be periodically updated by the mobile station clothescasting application 310 to form a clothing history database for specific article of clothing. The history may be used in conjunction with future transferring or sale of the article of clothing. For example, if the United States President's wife, the First Lady were an application user, the dress she wore to the President's inauguration may be recorded along with the various information as described herein, and stored in the clothing information database server 117 or to a blog server such as blog server 119. The clothing history information may then be used for various purposes such as, but not limited to, future museum displays, auctions, etc. and may be transferred along with the article of clothing.

It is to be understood that other services and business models are conceivable using the various embodiments and that while specific embodiments have been disclosed herein, such embodiments are not a limitation on other similar embodiments that may be conceived that would remain in accordance with the present invention.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile station, the method comprising:
scanning at least one identification tag, said identification tag associated with an article of clothing; and
creating a markup language tag, said markup language tag defining data from said identification tag.

2. The method of claim 1, further comprising:
creating a record for said article of clothing, said record comprising said data and said markup language tag.

3. The method of claim 2, further comprising:
creating a clothing set tag markup language tag for indicating the start of data for a particular set of clothing; and
creating a clothing instance tag markup language tag for indicating the start of data for a particular article of clothing.

4. The method of claim 3, further comprising:
creating a clothing location tag markup language tag for indicating the start of a single instance of location data within a clothing set tag data set.

5. The method of claim 3, further comprising:
creating for each clothing instance tag markup tag, an item name tag, a date tag, and a time tag.

6. The method of claim 4, further comprising:
creating as part of said location data, a coordinate tag, an address tag and a map link tag;
performing a server lookup and obtaining an address and a and a map link corresponding to a location of said mobile station.

7. The method of claim 1, wherein creating a markup language tag further comprises:
creating one of a Hypertext Markup Language (HTML) tag or a Extensible Markup Language (XML) tag.

8. The method of claim 1, further comprising:
receiving external data containing a plurality of markup language tags corresponding to an external clothing set and having external clothing set data associated with said external clothing set;
performing a comparison of said external clothing set data to said record; and
displaying a result of said comparison.

9. The method of claim 8, further comprising:
selecting an external user, said external user corresponding to a an external mobile station having said external data;
requesting said external data by using a push-to-x button press of said mobile station.

10. The method of claim 8, wherein receiving external data further comprises:
receiving a Really Simple Syndication (RSS) feed, wherein said RSS feed provides said external data.

11. The method of claim 9, wherein selecting an external user further comprises:
accessing a contact list of said mobile station; and
selecting a member of said contact list as said external user.

12. A mobile station, comprising:
a transponder reader coupled to a processor, the processor being configured to create a record using data from scanning, by said transponder reader, a transponder tag associated with an article of clothing, said record comprising at least one markup language tag for defining said data.

13. The mobile station of claim 12, wherein said processor is further configured to provide an user interface for entering additional data associated with said article of clothing, said additional data comprising an indication of whether a particular person was present at an event, a time of arrival for said particular person, and a departure time of said particular person.

14. The mobile station of claim 13, wherein said processor is further configured to provide a user interface for retrieving said record by searching an attribute of said article of clothing.

15. The mobile station of claim 12, wherein said processor is further configured to create a clothing set tag markup language tag for indicating the start of data for a particular set of clothing; and create a clothing instance tag markup language tag for indicating the start of data for a particular article of clothing.

16. The mobile station of claim 15, wherein said processor is further configured to create a clothing location tag markup language tag for indicating the start of a single instance of location data within a clothing set tag data set.

17. The mobile station of claim 15, wherein said processor is further configured to create for each clothing instance tag markup tag, an item name tag, a date tag, and a time tag.

18. The mobile station of claim 12, wherein said at least one markup tag is one of a Hypertext Markup Language (HTML) tag or a Extensible Markup Language (XML) tag

19. The mobile station of claim 18, further comprising a wireless transceiver coupled to said processor, wherein said processor is further configured to create a message comprising said at least one markup language tag and send said message to at least one other mobile station.

20. The mobile station of claim 19, wherein said processor is further configured to process a message received by said wireless transceiver, said message containing a plurality of markup language tags corresponding to an external clothing set and having external clothing set data associated with said external clothing set; perform a comparison said external clothing set data to said record and display a results of said comparison.
